(19) United States
(12) Patent Application Publication
(10) Pub. No.: US 2024/0216930 A1
(43) Pub. Date: Jul. 4, 2024

(54) SHOWER DEVICE

(71) Applicant: TOTO LTD., Kitakyushu-shi (JP)

(72) Inventors: Ryohei YAITA, Kitakyushu-shi (JP); Takahiro NAKASHIMA, Kitakyushu-shi (JP); Hiroki SEKI, Kitakyushu-shi (JP); Zuhe CHEN, Kitakyushu-shi (JP); Takehiro YAMORI, Kitakyushu-shi (JP)

(73) Assignee: TOTO LTD., Kitakyushu-shi (JP)

(21) Appl. No.: 18/538,318

(22) Filed: Dec. 13, 2023

(30) Foreign Application Priority Data
Dec. 28, 2022 (JP) 2022-211337
Dec. 28, 2022 (JP) 2022-211338
Sep. 26, 2023 (JP) 2023-162465
Sep. 26, 2023 (JP) 2023-162466
Oct. 17, 2023 (JP) 2023-178587

(51) Int. Cl. B05B 1/06; E03C 1/04

(52) U.S. Cl. CPC B05B 1/06; E03C 1/0408; B05B 1/3415

(57) ABSTRACT

There is provided a shower device that allows a user to continue to take a shower in a relaxed state for a long time. The present invention provides a shower device (1) fixed to enable a user to be showered from above with shower spouting water, the shower device comprising: a shower head main body (4), and a plurality of nozzle units (10) provided in the shower head main body at intervals so as to form the shower spouting water surrounding a head of the user standing below the shower head main body, in which each nozzle unit is configured so that the spouted hot water falls while spreading downward.

### BACKGROUND OF THE INVENTION

### Field of the Invention

The present invention relates to a shower device, and more particularly, to a shower device fixed to enable a user to be showered from above with shower spouting water.

### Description of the Related Art

A shower device is disclosed in Japanese Patent Laid Open No. 2022-15192 (Patent Literature 1). The shower device is formed in a disk shape, and is used by being attached to a ceiling. A number of nozzle holes are arranged on a circumference of a peripheral edge of the disk-shaped shower device, and hot water is spouted linearly from each nozzle hole.

The present inventors have developed a shower device that can be used to simply wash a user's body as well as allows a user to be showered with shower spouting water falling from above in a relaxed state for a relatively long time to enjoy a showering time, thereby providing a fatigue recovery effect and a stress elimination effect. In the shower device disclosed in Patent Literature 1, the nozzle holes are arranged in the peripheral edge of a shower head formed in a disk shape, causing the shower spouting water to be less likely to be applied directly on a face of the user standing below the center of the shower head. Therefore, the user taking a shower can continue to take a shower for a long time with relatively less stuffy feeling.

However, in the shower device disclosed in Patent Literature 1, since shower spouting water is spouted linearly from each of the nozzle holes arranged on the circumference at equal intervals, an area for spouting the water landing on a body of the user taking a shower is small, which makes it impossible to sufficiently envelop the body of the user in the spouted hot water. Therefore, for example, when the atmospheric temperature in the bath room is low, the user is affected by the outside air temperature, and feels chilly while taking a shower, which leads to a problem in that the user cannot continue to take a shower for a long time.

In contrast, in the shower device disclosed in Patent Literature 1, it is conceivable that the number of nozzle holes are significantly increased or film-like water is spouted over the entire periphery of the user to thereby envelop the body of the user in hot water. However, when shower spouting water is thus spouted, the periphery of a head of the user is enveloped by the shower spouting water, and hot air of the showering hot water is filled around the head of the user, which leads to a problem in that the user feels hot and stuffy. Therefore, there is a problem in that it is difficult for the user to continue to take a shower in a relaxed state for a long time.

Accordingly, the present invention has an object to provide a shower device that allows a user to continue to take a shower in a relaxed state for a long time.

### SUMMARY OF THE INVENTION

In order to solve the above described problems, the present invention provides a shower device fixed to enable a user to be showered from above with shower spouting water, the shower device comprising a shower head main body, and a plurality of nozzle units provided in the shower head main body at intervals so as to form the shower spouting water surrounding a head of the user standing below the shower head main body, wherein each of the nozzle units is configured so that the spouted water falls while spreading downward.

According to the present invention configured as described above, since the shower device is fixed to enable a user to be showered from above with shower spouting water, the user can take a shower without having to hold the shower head main body with user's hand. Since the plurality of nozzle units are provided in the shower head main body at intervals, there are gaps in water spouted from the nozzle units in the vicinity of the shower head main body, which can prevent hot air from filling a space surrounded by the shower spouting water. This can prevent the user taking a shower for a long time from feeling hot and stuffy. Since the water spouted from each of the nozzle units falls while spreading, the water can land on the body of the user standing below the shower head main body over a large area, and the landed water further spreads over the body surface, whereby the body can be sufficiently enveloped by the water. As a result, even when the atmospheric temperature is low, the user taking a shower is less likely to feel chilly, whereby the user can continue to take a shower for a long time.

In the present invention, preferably, each of the nozzle units is configured so that the spouted water joins with each other at a position falling a predetermined distance from each of the nozzle units, and a water film is formed around a body of the user.

According to the present invention configured as described above, since the water spouted from each of the nozzle units joins with each other at a position where the water falls a predetermined distance from each of the nozzle units, the air permeability between the inside and outside of the space surrounded by the shower spouting water can be ensured to the position where the water joins with each other, whereby the hot air can be prevented from filling the inside of the space. The body of the user can be sufficiently enveloped by the water below the position where the spouted water joins with each other, which makes it possible to sufficiently warm the body of the user.

In the present invention, preferably, each of the nozzle units is oriented so that a space surrounded by the spouted water is formed to narrow downward.

According to the present invention configured as described above, since the space surrounded by the spouted water is formed to narrow downward, the sufficient air permeability can be ensured in an upper portion of the space surrounded by the water. On the other hand, the space is reduced in size in a lower portion of the space surrounded by the water, which makes it easy to ensure the moisture-retaining property in the space, makes it possible to envelop the user by a relatively small volume of water, and makes it possible to sufficiently warm the user while achieving water saving.

In the present invention, preferably, the shower head main body is formed into a ring shape.

According to the present invention configured as described above, since the shower head main body is formed in a ring shape, the air in the space surrounded by the shower spouting water flows out to the outside through the interior of the shower head main body, whereby the hot air can be prevented from filling the inside of the space surrounded by the shower spouting water.

In the present invention, preferably, each of the nozzle units is configured so that the spouted water vibrates reciprocatingly in a sine-wave pattern, whereby the spouted water falls while spreading downward.

According to the present invention configured as described above, even when the intervals between the nozzle units adjacent to each other are set to be widened, the body of the user can be sufficiently enveloped by the landed water, and the water can be saved while maintaining the force of the spouting water.

In the present invention, preferably, among the plurality of nozzle units, a first nozzle unit and a second nozzle unit are configured to spout water forming respective linearly-extending water landing regions with respect to a same side of a virtual water landing plane oriented in a vertical direction below the shower head main body, and the first nozzle unit and the second nozzle unit are configured so that a first water landing region formed by the first nozzle unit and a second water landing region formed by the second nozzle unit at least partially overlap with each other in the vertical direction on the same side of the virtual water landing plane.

According to the present invention configured as described above, the first water landing region and the second water landing region at least partially overlap with each other in the vertical direction. Therefore, the water that lands on the first water landing region and flows downward on the body surface of the user and the water that lands on the second water landing region and falls downward interfere with each other on the body surface of the user, which makes it easy for the water to stay on the body surface. This increases the volume of water staying on the body surface of the user taking a shower with respect to the volume of water spouted from the shower head main body, which enables a satisfactory water volume feeling to be provided for the user even when the volume of the water spouted from the shower head main body is relatively small. Since the time for which the water stays on the body surface of the user is increased, the water can provide a large amount of heat for the user, which makes it possible to sufficiently warm the body of the user. As a result, a satisfactory water volume feeling and warmth can be provided for the user while achieving water saving.

In the present invention, preferably, the first water landing region is formed above the second water landing region, the second nozzle unit is configured so that the spouted water falls while spreading in a horizontal direction, and the water that hits on the first water landing region and falls joins with the water that has landed on the second water landing region to spread in the horizontal direction.

According to the present invention configured as described above, the first water landing region is formed above the second water landing region, and the second nozzle unit is configured so that the water falls while spreading in the horizontal direction. Therefore, the water that lands on the first water landing region and flows downward is spread in the horizontal direction by the water that has been spouted from the second nozzle unit and has landed on the second water landing region while spreading in the horizontal direction. Therefore, the water having landed on the body surface of the user flows downward while spreading largely on the body surface, which makes it possible to further increase the time for which the water stays on the body surface and to provide a satisfactory water volume feeling for the user.

In the present invention, preferably, among the plurality of nozzle units, a first nozzle unit and a second nozzle unit are configured to spout water forming respective linearly-extending water landing regions with respect to a same side of a virtual water landing plane oriented in a vertical direction below the shower head main body, and the first nozzle unit and the second nozzle unit are configured so that a first water landing region formed by the first nozzle unit crosses a second water landing region formed by the second nozzle unit on the same side of the virtual water landing plane.

According to the present invention configured as described above, the shower spouting water is spouted obliquely downward from each of the plurality of nozzle units of the shower head main body toward the user. The first nozzle unit and the second nozzle unit form the respective linearly-extending water landing regions with respect to a virtual water landing plane oriented in the vertical direction, and a first water landing region formed by the first nozzle unit crosses a second water landing region formed by the second nozzle unit on the same side of the virtual water landing plane.

According to the present invention, the first water landing region and the second water landing region cross. Therefore, in the body surface of the user, the water that has landed on the first water landing region and the water that has landed on the second water landing region interfere with each other at the crossing of the water landing regions, which makes it easy for the water to stay on the body surface of the user. This increases the volume of water staying on the body surface of the user taking a shower with respect to the volume of water spouted from the shower head main body, which enables a satisfactory water volume feeling to be provided for the user even when the volume of the water spouted from the shower head main body is relatively small. Since the time for which the water stays on the body surface of the user is increased, the water can provide a large amount of heat for the user, which makes it possible to sufficiently warm the body of the user. As a result, a satisfactory water volume feeling and warmth can be provided for the user while achieving water saving.

In the present invention, preferably, the first water landing region and the second water landing region cross in a V shape at a predetermined height below a substantial center in a left and right direction of the shower head main body on the virtual water landing plane.

According to the present invention configured as described above, the first water landing region and the second water landing region cross in a V shape at a predetermined height below a substantial center in the left-and-right direction of the shower head main body. This enables the first and second water landing regions to be formed at relatively high positions of the upper body of the user while preventing the shower spouting water from directly landing on the vicinity of the face of the user, which makes it possible to increase the time for which the landed water flows downward on the body surface of the user and to sufficiently warm the user.

In the present invention, preferably, the shower head main body is formed in a ring shape, and includes an annular portion provided with an annular passage in the annular portion, and a water supply portion that is coupled to the annular portion and provided with a plurality of distribution passages in the water supply portion, wherein the water flows into the annular passage from a plurality of portions via each of the distribution passages.

According to the present invention configured as described above, since the water flows into the annular passage from a plurality of portions via each of the distribution passages, a distance of the water supply passage passing from a water supply source to each of the nozzle units is uniform, and the water is supplied to each of the nozzle units at a relatively uniform water supply pressure. As a result, the flow rate of the water to be spouted from each of the nozzle units is more uniform, and a showering feeling felt by the user is more uniform. Since the water is supplied to each of the nozzle units uniformly, the relationship between the first water landing region and the second water landing region can be maintained as designed even when the water supply pressure to the shower head main body is low.

According to the shower device of the present invention, the user can continue to take a shower in a relaxed state for a long time.

### BRIEF DESCRIPTION OF THE DRAWINGS

FIG. 1 is a perspective view illustrating a state where a shower device according to a first embodiment of the present invention is installed in a shower room:

FIG. 2 is an enlarged cross-sectional view illustrating a shower head main body of the shower device according to the first embodiment of the present invention;

FIG. 3 is a perspective view of a fluid element provided in the shower device according to the first embodiment of the present invention;

FIG. 4 is a cross-sectional view taken along line IV-IV in FIG. 3;

FIG. 5 is a cross-sectional view taken along line V-V in FIG. 3;

FIG. 6 is a diagram schematically illustrating a user taking a shower with water spouted from the shower head main body of the shower device according to the first embodiment of the present invention;

FIG. 7 is a perspective view of an entire nozzle according to a modified example of a nozzle unit provided in the shower device according to the first embodiment of the present invention;

FIG. 8 is a partially enlarged cross-sectional view taken along line VIII-VIII in FIG. 7;

FIG. 9 is a partially enlarged cross-sectional view taken along line IX-IX in FIG. 7;

FIG. 10 is a perspective view illustrating a state where a user is taking a shower with shower spouting water from a shower device according to a second embodiment of the present invention;

FIG. 11 is a side view schematically illustrating shower spouting water landing on a virtual water landing plane oriented in the vertical direction in the shower device according to the second embodiment of the present invention;

FIG. 12 is an enlarged view schematically illustrating a state of hot water having landed on the virtual water landing plane oriented in the vertical direction in the shower device according to the second embodiment of the present invention;

FIG. 13 is a perspective view illustrating a state where a user is taking a shower with shower spouting water from a shower device according to a third embodiment of the present invention;

FIG. 14 is a perspective view illustrating a state where a user is taking a shower with shower spouting water from a shower device according to a fourth embodiment of the present invention;

FIG. 15 is a perspective view illustrating a state where a user is taking a shower with shower spouting water from a shower device according to a fifth embodiment of the present invention:

FIG. 16 is a perspective view illustrating a state where a user is taking a shower with shower spouting water from a shower device according to a sixth embodiment of the present invention;

FIG. 17 is a perspective view illustrating a shower device according to a seventh embodiment of the present invention;

FIG. 18 is a perspective view illustrating a state where an upper member of a shower head main body is detached in the shower device according to the seventh embodiment of the present invention;

FIG. 19 is a cross-sectional view illustrating a shower head main body provided in the shower device according to the seventh embodiment of the present invention;

FIG. 20 is an exploded perspective view illustrating an attachment structure of a nozzle unit in the shower device according to the seventh embodiment of the present invention;

FIG. 21 is a diagram illustrating an example of hot water spouted from a fluid element in the shower device according to the seventh embodiment of the present invention; and

FIG. 22 is a diagram schematically illustrating hot water spouted from first to third fluid elements provided in the shower head main body of the shower device according to the seventh embodiment of the present invention.

### DETAILED DESCRIPTION OF THE PREFERRED EMBODIMENTS

Next, a shower device according to embodiments of the present invention will be described with reference to the accompanying drawings.

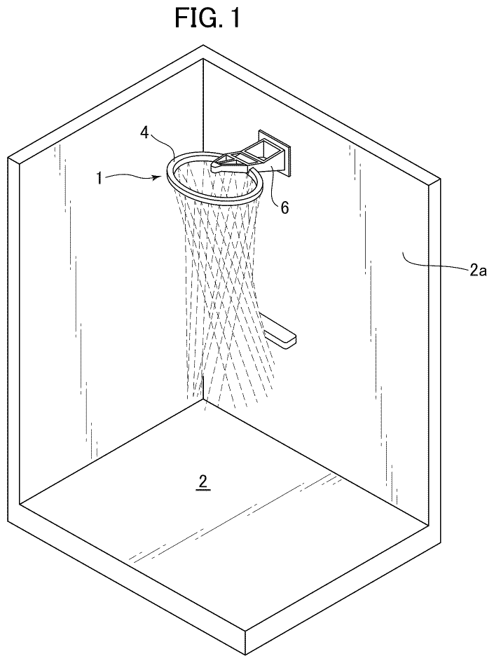

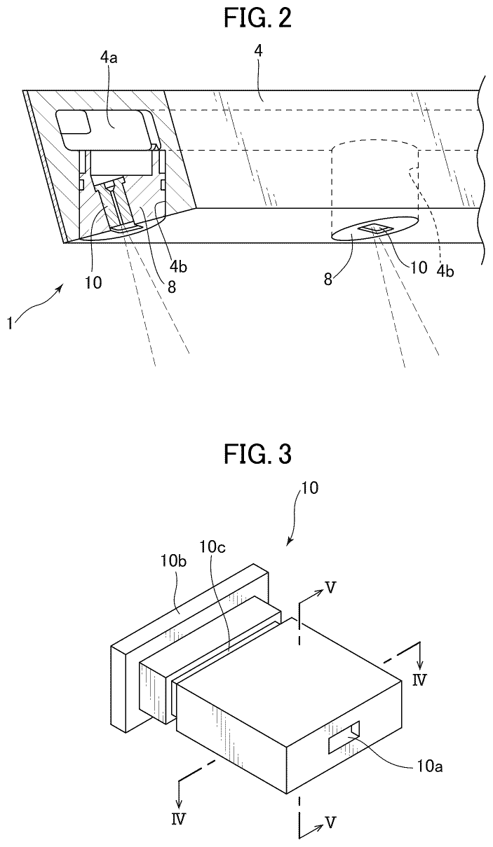

FIG. 1 is a perspective view illustrating a state where a shower device according to a first embodiment of the present invention is installed in a shower room. FIG. 2 is an enlarged cross-sectional view illustrating a shower head main body of the shower device according to the first embodiment of the present invention.

As illustrated in FIG. 1, a shower device 1 of the present embodiment is fixed to a side wall surface 2a of a shower room 2. The shower device 1 includes a shower head main body 4, and a support member 6 for attaching the shower head main body 4 to the side wall surface 2a.

The shower head main body 4 is an elliptical ring-shaped member as a whole, and is provided with a plurality of nozzle units arranged at intervals along the elliptical ring.

The support member 6 is a member attached to extend in a generally horizontal direction from an upper portion of the side wall surface 2a, and is configured to support the shower head main body 4 at a predetermined height. Furthermore, a water supply passage (not illustrated) is provided inside the support member 6, and hot water supplied through the water supply passage flows into the shower head main body 4, and is spouted from each nozzle unit.

In the present embodiment, the shower head main body 4 is fixed to the side wall surface 2a via the support member 6 extending from the side wall surface 2a, but the shower head main body may also be fixed to a ceiling surface via a support member extending from the ceiling surface. Alternatively, a columnar structure may extend upright from a floor surface of the shower room, etc., so that the shower head main body 4 can be fixed to the structure at a relatively elevated position above a user. Alternatively, the shower head main body may be fixed directly to the side wall surface or the ceiling surface not via the support member. In this specification, the manner in which “a shower head main body is fixed to a side wall surface or a ceiling wall surface” includes the manner in which the shower head main body is fixed via a support member and the manner in which the shower head main body is directly fixed to the side wall surface or the ceiling surface.”

Note that the shower device 1 is configured to spout water from each nozzle unit during use, and allow a user standing below the shower head main body 4 to be showered from above with shower spouting water. Since the nozzle units are provided along the ring-shaped shower head main body 4, the shower spouting water is formed to surround the head of the user standing below the shower head main body 4 by the nozzle units. That is, as viewed from the user standing below the shower head main body 4, the spouting water lands on the body of the user from the front surface, the rear surface, and the right and left side surfaces, and the head of the user is surrounded by the shower spouting water.

Next, an internal structure of the shower head main body 4 will be described with reference to FIG. 2.

As described above, the shower head main body 4 is formed into an elliptical ring shape as a whole. A water supply passage 4a extending along the ring shape is provided inside the shower head main body 4. Hot water supplied through a water supply passage (not illustrated) formed inside the support member 6 flows into the water supply passage 4a in the shower head main body 4, and is supplied to the entire shower head main body 4.

Furthermore, a plurality of nozzle unit attaching concave portions 4b are provided at a predetermined interval along the water supply passage 4a in the shower head main body 4. Each of these nozzle unit attaching concave portions 4b is a cylindrical recess extending in the vertical direction, and is formed to communicate with the water supply passage 4a and is open toward a lower surface of the shower head main body 4. That is, the hot water flowing in the water supply passage 4a of the shower head main body 4 flows into the nozzle unit attaching concave portions 4b.

Furthermore, a nozzle unit holding member 8 is fitted into each nozzle unit attaching concave portion 4b. The nozzle unit holding member 8 is a cylindrical member, and is water-tightly attached in each nozzle unit attaching concave portion 4b. Furthermore, a fluid element 10 which is a nozzle unit is held in each nozzle unit holding member 8. This fluid element 10 is held by the nozzle unit holding member 8 so that hot water is spouted from a lower surface of the nozzle unit holding member 8. The fluid element 10 is held by the nozzle unit holding member 8 so as to face obliquely downward, and the fluid element 10 spouts the hot water obliquely downward toward a center of the elliptical shower head main body 4. Note that the nozzle unit holding member 8 is configured to be detachably attached to the nozzle unit attaching concave portion 4b.

Next, a configuration of the fluid element 10, which is a nozzle unit, provided in the shower device 1 will be described with reference to FIGS. 3 to 5.

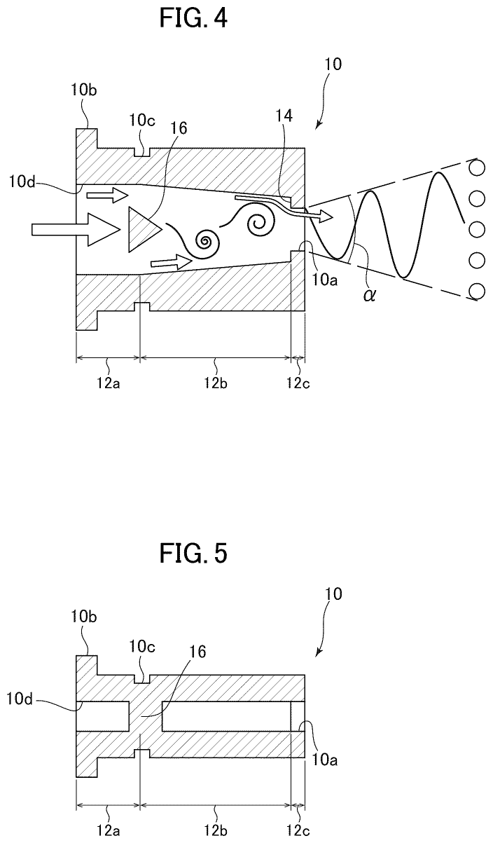

FIG. 3 is a perspective view of the fluid element provided in the shower device according to the first embodiment of the present invention. FIG. 4 is a cross-sectional view taken along line IV-IV in FIG. 3, and FIG. 5 is a cross-sectional view taken along line V-V in FIG. 3.

As illustrated in FIG. 3, the fluid element 10 is a generally thin rectangular parallelepiped member, in which a rectangular water spouting port 10a is provided in an end surface on the front surface side of the fluid element 10, and a flange portion 10b is formed at an end portion on the back surface side of the fluid element 10. Furthermore, a groove 10c is provided parallel to the flange portion 10b to encircle the fluid element 10. An O-ring (not illustrated) is fitted into the groove 10c, thereby ensuring the water tightness between the groove 10c and the nozzle unit holding member 8.

As illustrated in FIG. 4, inside the fluid element 10, a passage having a rectangular cross-section is formed to pass through the fluid element 10 in a longitudinal direction. This passage is formed to include a water supply passage 12a, a vortex street passage 12b, and a rectifying passage 12c in order from the upstream side.

The water supply passage 12a is a linear passage having a rectangular cross-section in which a cross-sectional area is constant, the passage extending from a water inlet 10d on the back surface side of the fluid element 10.

The vortex street passage 12b is a passage having a rectangular cross-section, the passage being provided (with no step) on the downstream side of the water supply passage 12a to communicate with the water supply passage 12a. That is, a downstream end of the water supply passage 12a and an upstream end of the vortex street passage 12b have the same dimensional shape. A pair of wall surfaces (both side wall surfaces) facing each other of the vortex street passage 12b are formed to be tapered so that a flow channel cross-sectional area is reduced toward the downstream side throughout the vortex street passage 12b. That is, the vortex street passage 12b is formed to become thinner toward the downstream side, so that the width becomes gradually narrower toward the downstream side.

The rectifying passage 12c is a passage having a rectangular cross-section, the passage being provided on the downstream side of the vortex street passage 12b to communicate with the vortex street passage 12b, and is formed linearly to have a constant cross-sectional area. The hot water including the vortex street guided by the vortex street passage 12b is rectified by this rectifying passage 12c, and then is spouted from the water spouting port 10a. A flow channel cross-sectional area of the rectifying passage 12c is configured to be smaller than a flow channel cross-sectional area of a downstream end portion of the vortex street passage 12b, and a step portion 14 is formed between the vortex street passage 12b and the rectifying passage 12c. A step portion wall surface which is a surface of the step portion 14 is oriented in a direction perpendicular to a central axis of the vortex street passage 12b.

On the other hand, as illustrated in FIG. 5, wall surfaces (a ceiling surface and a floor surface) facing each other in the height direction of the water supply passage 12a, the vortex street passage 12b, and the rectifying passage 12c are all provided on the same plane. That is, the heights of the water supply passage 12a, the vortex street passage 12b, and the rectifying passage 12c are all the same and constant.

Next, a hot water collision part 16 is formed at the downstream end portion of the water supply passage 12a (in the vicinity of a connection portion between the water supply passage 12a and the vortex street passage 12b), and is provided to occlude a portion of the flow channel cross-section of the water supply passage 12a. The hot water collision part 16 is a triangular prism-shaped portion extending in the height direction of the water supply passage 12a to connect the wall surfaces (the ceiling surface and the floor surface) facing each other, and is arranged in an island shape at a center in the width direction of the water supply passage 12a. The cross-section of the hot water collision part 16 is formed into a shape of isosceles triangle, in which an oblique side of the isosceles triangle is arranged to be perpendicular to the central axis of the water supply passage 12a and a vertex of the isosceles triangle is arranged to be oriented toward the downstream side.

Providing the hot water collision part 16 allows Karman vortices to be generated on the downstream side of the hot water collision part 16, whereby the hot water spouted from the water spouting port 10a is reciprocatingly vibrated. That is, the hot water supplied from the water supply passage (not illustrated) in the support member 6 flows into the water supply passage 4a (FIG. 2) in the shower head main body 4, and further flows into the water inlet 10d in each fluid element 10 held by the nozzle unit holding member 8. The hot water having flowed into the water supply passage 12a from the water inlet 10d in each fluid element 10 collides with the hot water collision part 16 provided to occlude a portion of the flow channel. This allows a street of the Karman vortices rotating in alternately opposite directions to be formed on the downstream side of the hot water collision part 16. The Karman vortices formed by the hot water collision part 16 grow while being guided by the vortex street passage 12b formed to be tapered, and then reaches the rectifying passage 12c.

The hot water having flowed into the rectifying passage 12c on the downstream side of the vortex street passage 12b is rectified here. The hot water spouted from the water spouting port 10a through the rectifying passage 12c is bent based on the flow velocity distribution at the water spouting port 10a, and a water spouting direction of the hot water changes as a portion with a high flow velocity moves in an up-and-down direction in FIG. 4. That is, in the state where the portion with a high flow velocity of the hot water is located at the upper end of the water spouting port 10a in FIG. 4, the hot water is jetted downward, and in the state where the portion with a high flow velocity of the hot water is located at the lower end of the water spouting port 10a, the hot water is jetted upward. In this way, Karman vortices are alternately generated on the downstream side of the hot water collision part 16, whereby the flow velocity distribution occurs at the water spouting port 10a, and the jet deflects. Since a position of the portion with a high flow velocity moves reciprocatingly as the vortex street progresses, the jetted hot water also vibrates reciprocatingly in a generally sine wave pattern in a predetermined vibration plane (a plane parallel to drawing sheet of FIG. 4).

Here, as illustrated in FIG. 2, in the present embodiment, since each fluid element 10 is attached so as to face obliquely downward, the hot water spouted from the water spouting port 10a of the fluid element 10 falls while spreading in a generally fan shape in the predetermined vibration plane. That is, the hot water spouted from the water spouting port 10a of the fluid element 10 vibrates reciprocatingly in a sine wave pattern, whereby the trajectory of the spouting water per constant time spreads in a fan shape. In the present embodiment, each fluid element 10 is attached to the shower head main body 4 so that the vibration plane thereof is oriented in a tangential direction (peripheral direction) of the elliptical shower head main body 4. This forms cylindrical shower spouting water having an elliptical cross section as a whole below the shower head main body 4, and the head of the user standing below the shower head main body 4 is surrounded by the shower spouting water.

Note that the hot water spouted from the water spouting port 10a of the fluid element 10 preferably spreads at an angle of about 10° or more in a downward direction. When the spread of the shower spouting water is too large, the shower spouting water falls without landing on the body of the user standing below the shower head main body 4, which leads to an increase in useless water volume and a decrease in water saving efficiency. On the other hand, when the spread of the shower spouting water is too small, an area in which water lands on the body of the user becomes small, which leads to an increase in the number of fluid elements 10 required to envelop the body of the user increases and a decrease in water saving efficiency. Accordingly, the spread angle α (FIG. 4) of the hot water spouted from the water spouting port 10a of the fluid element 10 is set to about 10° to 45°, and more preferably about 20° to about 30°. Since the shower spouting water falls while spreading in a fan shape, the intervals between the fluid elements 10 are set to about 30 to about 200 mm, and preferably about 43 to about 167 mm.

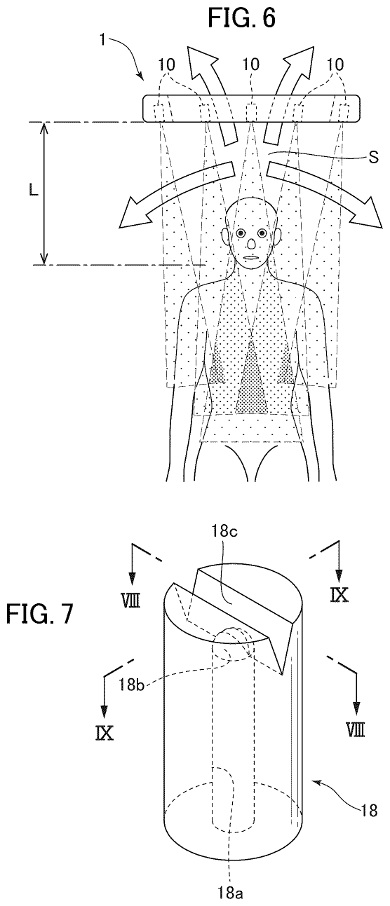

Next, an operation of the shower device 1 according to the first embodiment of the present invention will be described with reference to FIG. 6.

FIG. 6 is a diagram schematically illustrating a user taking a shower with shower spouting water spouted from the shower head main body 4 of the shower device 1 according to the first embodiment of the present invention.

As described above, the hot water spouted from the fluid elements 10 provided in the shower head main body 4 is spouted while vibrating reciprocatingly in a sine-wave pattern. Therefore, as illustrated in FIG. 6, the hot water spouted from each fluid element 10 falls while spreading in a generally fan shape. As described above, each fluid element 10 is attached to be inclined obliquely downward toward the center of the shower head main body 4 (FIG. 2). Therefore, a water spouting space S surrounded by the shower spouting water from the fluid elements 10 is formed to narrow downward. In the shower device 1 of the present embodiment, since the hot water is spouted from the fluid elements 10 provided in the shower head main body 4 while vibrating reciprocatingly in a sine wave pattern, even when the intervals between the fluid elements 10 are set to be widened, the body of the user can be enveloped by the hot water, and the water saving efficiency can be obtained while maintaining the force of the spouting water.

Furthermore, the fluid elements 10 are provided at predetermined intervals along the ring-shaped shower head main body 4. Therefore, as illustrated in FIG. 6, in a region (a region in the vicinity of the shower head main body 4) in which the width of the hot water spouted from each fluid element 10 is not sufficiently increased, there are gaps in hot water spouted from the fluid elements 10. This enables air in the water spouting space S surrounded by the shower spouting water from the fluid elements 10 to flow out to the outside of the water spouting space S through the gaps in shower spouting water. In the present embodiment, since the shower head main body 4 is formed in a ring shape, the air in the water spouting space S can flow out to above the shower head main body 4 through the interior of the shower head main body 4. Therefore, the interior of the water spouting space S is maintained at a comfortable temperature without being filled with the hot air of the hot water spouted into the water spouting space S.

On the other hand, since the hot water spouted from each fluid element 10 falls while spreading in the horizontal direction, the spouted hot water forms a flat fan shape as a whole. The fan-shaped hot water spouted from each fluid element 10 joins with each other at a position where the hot water falls a predetermined distance L. Since the flat fan-shaped hot water spouted from each fluid element 10 is oriented in the tangential direction of the ring-shaped shower head main body 4, the head and body of the user are surrounded by the fan-shaped hot water spouted from each element 10, and the water film is formed around the body of the user. Therefore, a portion above a position downward by the predetermined distance L from the shower head main body 4, of the water spouting space S has the gaps in the shower spouting water, and therefore acts as a hot air escape space. Additionally, a portion below the position downward by the predetermined distance L from the shower head main body 4, of the water spouting space S, in which the hot water spouted from each fluid element 10 joins with each other, and the water film for surrounding the body of the user is formed, acts as a hot air holding space. Note that the predetermined distance L is preferably set so that the water can also land on the upper body of the relatively small user (for example, body height of about 150 cm).

In this way, the hot water spouted from each fluid element 10, after falling the predetermined distance L, form the water film that envelops the body of the user, while hitting on the upper body of the user, whereby the body of the user can be sufficiently warmed by the hot water. Therefore, even when the atmospheric temperature in the shower room 2 is low, the user can continue to take a shower for a long time without feeling chilly.

According to the shower device of the first embodiment of the present invention, since the shower head main body 4 is fixed to the side wall surface 2a, the user can take a shower without having to hold the shower head main body 4 with user's hand. Since the plurality of fluid elements 10, which are the nozzle units, are provided in the shower head main body 4 at intervals, there are gaps in hot water spouted from the fluid elements 10 in the vicinity of the shower head main body 4, which can prevent hot air from filling the water spouting space S surrounded by the shower spouting water. This can prevent the user taking a shower for a long time from feeling hot and stuffy. Since the hot water spouted from each fluid element 10 falls while spreading, the water can land on the body of the user standing below the shower head main body 4 over a large area, and the landed hot water further spreads over the body surface, whereby the body can be sufficiently enveloped by the hot water. As a result, even when the atmospheric temperature is low, the user taking a shower is less likely to feel chilly, whereby the user can continue to take a shower for a long time.

According to the shower device of the present embodiment, since the hot water spouted from each fluid element 10 joins with each other at a position where the hot water falls a predetermined distance L from the fluid elements 10 (FIG. 6), the air permeability between the inside and outside of the water spouting space S surrounded by the shower spouting water can be ensured to the position where the hot water joins with each other, whereby the hot air can be prevented from filling the inside of the water spouting space S. The body of the user can be sufficiently enveloped by the hot water below the position where the spouted hot water joins with each other, which makes it possible to sufficiently warm the body of the user.

Furthermore, according to the shower device of the present embodiment, since the water spouting space S surrounded by the spouted hot water is formed to narrow downward, the sufficient air permeability can be ensured in an upper portion of the water spouting space S surrounded by the hot water. On the other hand, the water spouting space S is reduced in size in a lower portion of the water spouting space S surrounded by the hot water, which makes it easy to ensure the moisture-retaining property in the space and makes it possible to sufficiently warm the user.

According to the shower device of the present embodiment, since the shower head main body 4 is formed in a ring shape, the air in the water spouting space S surrounded by the shower spouting water flows out to the outside through the interior of the shower head main body 4, whereby the hot air can be prevented from filling the inside of the water spouting space S surrounded by the shower spouting water.

Note that in the above-described embodiment, the nozzle unit is formed by the fluid element 10, and this fluid element 10 achieves the shower spouting water in which the hot water falls while spreading. In contrast, as a modified example, a configuration of a nozzle for spouting hot water can also achieve a nozzle unit which causes the hot water to fall while spreading.

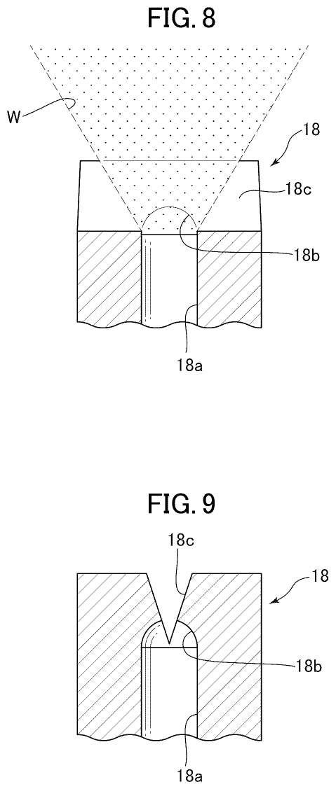

FIGS. 7 to 9 each are a diagram illustrating an example of a nozzle for achieving shower spouting water in which hot water falls while spreading. FIG. 7 is a perspective view illustrating the entire nozzle. FIG. 8 is a partially enlarged cross-sectional view taken along line VIII-VIII in FIG. 7, and FIG. 9 is a partially enlarged cross-sectional view taken along line IX-IX in FIG. 7.

As illustrated in FIG. 7, a nozzle 18, which is a nozzle unit, is formed into a cylindrical shape as a whole, and can be used by being fitted into each nozzle unit attaching concave portion 4b of the shower head main body 4. As illustrated in FIGS. 7 to 9, a passage 18a having a circular cross section is formed along a central axis of the cylindrical nozzle 18. A dome-shaped (hemispherical-shaped) inner wall surface 18b is formed at a distal end of the passage 18a having a circular cross section. Furthermore, a groove 18c having a V-shaped cross section is provided in a distal end surface of the nozzle 18, and the deepest portion of the groove 18c is formed by cutting a part of the dome-shaped inner wall surface 18b.

With this configuration, the hot water guided by the water supply passage 4a in the shower head main body 4 flows into the passage 18a of the nozzle 18, the hot water guided by the passage 18a flows out to a bottom of the groove 18c having a V-shaped cross section from a notch provided in the inner wall surface 18b, and then is spouted downward (an upper portion in FIGS. 7 to 9). In this way, as illustrated in FIG. 8, hot water W spouted from the nozzle 18 falls while spreading in a conical shape or an elliptic cone shape. Note that in the present modified example, each nozzle 18 is attached to the shower head main body 4 so that a long axis of the elliptic cone is oriented in a tangential direction of the elliptical shower head main body 4. In the present modified example, the nozzle unit is provided to the shower head main body 4 by attaching the nozzle 18 to the shower head main body 4, but alternatively, a nozzle hole may be formed directly in a member forming the shower head main body 4 to provide the nozzle unit.

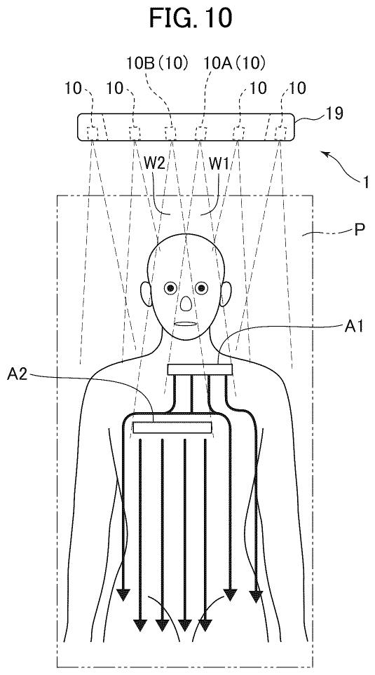

Next, an operation of a shower device according to a second embodiment of the present invention will be described with reference to FIGS. 10 to 12.

The shower device of the present embodiment is different from that of the above-described first embodiment of the present invention in a direction (angle) in which each fluid element is attached to the shower head main body. As a result, the form of spouting water spouted from the shower device is different from that of the above-described first embodiment. Accordingly, hereinafter, the form of spouting water generated by the shower device according to the second embodiment of the present invention will be described, and the same configuration as that in the first embodiment is not described.

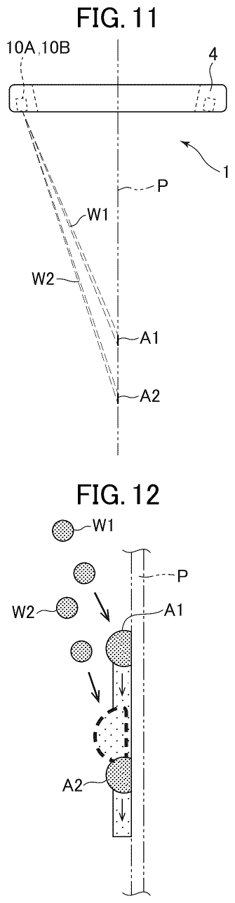

FIG. 10 is a front view schematically illustrating a user taking a shower with shower spouting water spouted from a shower head main body 19 of the shower device according to the second embodiment of the present invention. FIG. 11 is a side view schematically illustrating shower spouting water landing on a virtual water landing plane oriented in the vertical direction in the shower device according to the second embodiment of the present invention. FIG. 12 is an enlarged view schematically illustrating a state of hot water having landed on the virtual water landing plane oriented in the vertical direction in the shower device according to the second embodiment of the present invention.

As in the first embodiment, the hot water spouted from the fluid elements 10 provided in the shower head main body 19 is spouted while vibrating reciprocatingly in a sine wave pattern. Therefore, as illustrated in FIG. 10, the hot water spouted from each fluid element 10 falls while generally spreading in a fan shape. Since each fluid element 10 is attached to be inclined obliquely downward toward the center of the shower head main body 19 (similar to FIG. 2 of the first embodiment), the shower spouting water spouted from each fluid element 10 lands on a virtual water landing plane P oriented in the vertical direction below the shower head main body 19. Since each fluid element 10 is attached so that the vibration plane thereof is oriented in a tangential direction of the elliptical shower head main body 19, the shower spouting water spouted from each fluid element 10 forms, on the virtual water landing plane P, a linearly-extending water landing region oriented in a generally horizontal direction. Note that in the shower device of the present embodiment, since the hot water is spouted from the fluid elements 10 provided in the shower head main body 19 while vibrating reciprocatingly in a sine wave pattern, even when the intervals between the fluid elements 10 are set to be widened, the body of the user can be enveloped by the hot water, and the water saving efficiency can be obtained while maintaining the force of the spouting water.

As illustrated in FIGS. 10 and 11, in the present embodiment, shower spouting water W1 spouted from the fluid elements 10A, which is a first nozzle unit among the plurality of fluid elements 10, forms a linearly-extending first water landing region A1 oriented in the generally horizontal direction, on one surface (a left side surface in FIG. 11) of the virtual water landing plane P. Similarly, shower spouting water W2 spouted from a fluid element 10B, which is a second nozzle unit among the plurality of fluid elements 10, forms a linearly-extending second water landing region A2 oriented in the generally horizontal direction, on the same plane of the virtual water landing plane P. In the example illustrated in FIGS. 10 and 11, the virtual water landing plane P is set to include a long axis of the elliptical shower head main body 19. Furthermore, as illustrated in FIG. 11, the fluid element 10A, which is the first nozzle unit, and the fluid element 10B, which is the second nozzle unit, are arranged on one side of the water landing plane P, and on the same plane of the water landing plane P, the fluid element 10A forms the first water landing region A1 and the fluid element 10B forms the second water landing region A2.

Here, as illustrated in FIG. 11, since the angle at which the fluid element 10A, which is the first nozzle unit, spouts the hot water to the water landing plane P is larger than the angle at which the fluid element 10B, which is the second nozzle unit, spouts the hot water to the water landing plane P, the first water landing region A1 is formed above the second water landing region A2. That is, the first water landing region A1 and the second water landing region A2 on the water landing plane P are separated by a predetermined distance in an up-and-down direction. Furthermore, as illustrated in FIG. 10, the first water landing region A1 formed by the fluid element 10A and the second water landing region A2 formed by the fluid element 10B partially overlap with each other in the vertical direction. That is, a vertical projection of the first water landing region A1 formed on the water landing plane P overlaps with at least a part of the second water landing region A2 formed on the water landing plane P.

Therefore, as illustrated in FIG. 12, the hot water that is spouted from the fluid element 10A, hits on the first water landing region A1, and then falls joins with the hot water that is spouted from the fluid element 10B, falls while spreading, and then lands on the second water landing region A2. In this way, the hot water that hits on the first water landing region A1 and then falls joins with the hot water that has landed on the second water landing region A2, whereby the hot water falling from the first water landing region A1 is temporarily blocked, which causes an increase in the time for which the hot water stays on the water landing plane P (the body surface of the user).

This can provide a satisfactory water volume feeling for the user even when the volume of the water spouted from the shower head main body 19 is relatively small. Since the time for which the hot water stays on the body surface of the user is increased, the hot water can provide a large amount of heat for the user, which makes it possible to sufficiently warm the body of the user. The shower spouting water spouted from the fluid element 10B, which is the second nozzle unit, lands on the second water landing region A2 while spreading in the horizontal direction. Therefore, the hot water that lands on the first water landing region and flows downward is spread in the horizontal direction by the hot water that has landed on the second water landing region A2, which makes it easy for the hot water to stay on the body surface of the user.

Note that in the present embodiment, the two fluid elements 10A and 10B arranged on the front surface side of the user standing below the shower head main body 19 serve as the first and second nozzle units, but alternatively, any two of the plurality of nozzle units provided in the shower head main body 19 can serve as the first and second nozzle units.

According to the shower device of the second embodiment of the present invention, the first water landing region A1 and the second water landing region A2 partially overlap with each other in the vertical direction (FIG. 10). Therefore, the hot water that lands on the first water landing region A1 and flows downward on the body surface of the user and the hot water that lands on the second water landing region A2 and falls downward interfere with each other on the body surface of the user, which makes it easy for the hot water to stay on the body surface. This increases the volume of hot water staying on the body surface of the user taking a shower with respect to the volume of water spouted from the shower head main body 19, which enables a satisfactory water volume feeling to be provided for the user even when the volume of the water spouted from the shower head main body 19 is relatively small. Since the time for which the hot water stays on the body surface of the user is increased, the hot water can provide a large amount of heat for the user, which makes it possible to sufficiently warm the body of the user. As a result, a satisfactory water volume feeling and warmth can be provided for the user while achieving water saving.

According to the shower device of the present embodiment, the first water landing region A1 is formed above the second water landing region A2, and the fluid element 10B, which is the second nozzle unit, is configured so that the hot water falls while spreading in the horizontal direction. Therefore, the hot water that lands on the first water landing region A1 and flows downward is spread in the horizontal direction by the hot water that has been spouted from the fluid element 10B and has landed on the second water landing region A2 while spreading in the horizontal direction. Therefore, the hot water having landed on the body surface of the user flows downward while spreading largely on the body surface, which makes it possible to further increase the time for which the hot water stays on the body surface and to provide a satisfactory water volume feeling for the user.

Note that in the above-described embodiment, the nozzle unit is formed by the fluid element 10, and this fluid element 10 causes the hot water to fall while spreading, so that the linearly extending water landing region is formed on the water landing plane. In contrast, as a modified example, a configuration of a nozzle for spouting hot water can also achieve a nozzle unit which causes the hot water to fall while spreading.

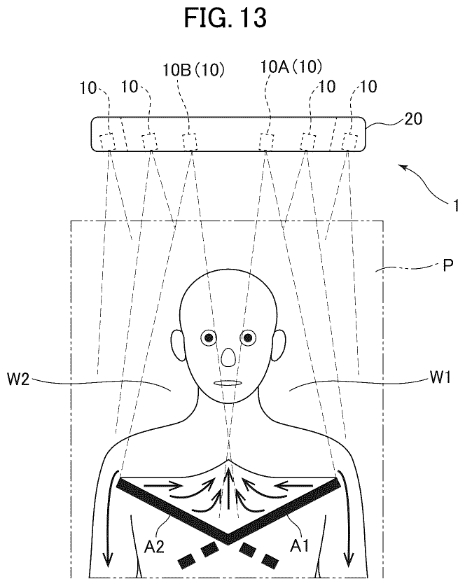

Next, an operation of a shower device according to a third embodiment of the present invention will be described with reference to FIG. 13.

The shower device of the present embodiment is different from that of the above-described second embodiment in a direction of shower spouting water spouted from each fluid element provided in a shower head main body. Accordingly, hereinafter, only features of the third embodiment of the present invention which are different from those of the second embodiment will be described, and the same configuration, functions, and effects as those in the second embodiment are not described. FIG. 13 is a front view illustrating a state where the user is taking a shower with shower spouting water from the shower device according to the third embodiment of the present invention.

A shower head main body 20 provided in the shower device of the present embodiment is also formed into an elliptical ring shape as a whole in the same manner as in the first and second embodiments, and is provided with a plurality of fluid elements 10 as nozzle units. As described above, the hot water spouted from the fluid elements 10 is spouted while vibrating reciprocatingly in a sine wave pattern, and falls while spreading in a generally fan shape. Each fluid element 10 is attached to be inclined obliquely downward toward the center of the shower head main body 20, and the shower spouting water spouted from each fluid element 10 lands on a virtual water landing plane P oriented in the vertical direction below the shower head main body 20. Furthermore, in the above-described second embodiment, each fluid element 10 is attached so that the vibration plane thereof is oriented in a tangential direction of the elliptical shower head main body 19, and the linearly-extending water landing region oriented in the generally horizontal direction is formed on the water landing plane P. In contrast, in the present embodiment, the vibration plane of each fluid element 10 is inclined by a predetermined angle with respect to the elliptical shower head main body 20, and an inclined water landing region is formed on the water landing plane P.

In other words, as illustrated in FIG. 13, in the present embodiment, shower spouting water W1 spouted from a fluid element 10A, which is a first nozzle unit among the plurality of fluid elements 10 provided in the shower head main body 20, forms, on a virtual water landing plane P, a linearly-extending first water landing region A1 which is inclined to be lower toward the center side of the shower head main body 20 and to be higher toward the end portion of the shower head main body 20. On the other hand, shower spouting water W2 spouted from a fluid element 10B, which is a second nozzle unit among the plurality of fluid elements 10, also forms, on the same plane of the virtual water landing plane P, a linearly extending second water landing region A2 which is inclined to be lower toward the center side of the shower head main body 20 and to be higher toward the end portion of the shower head main body 20. Also in the example illustrated in FIG. 13, the virtual water landing plane P is set to include a long axis of the elliptical shower head main body 20. Furthermore, the fluid element 10A, which is the first nozzle unit, and the fluid element 10B, which is the second nozzle unit, are arranged on one side of the water landing plane P, and on the same plane of the water landing plane P, the fluid element 10A forms the first water landing region A1 and the fluid element 10B forms the second water landing region A2.

Here, since each vibration plane of the fluid element 10A, which is the first nozzle unit, and the fluid element 10B, which is the second nozzle unit is attached to the shower head main body 20 at a predetermined angle, the fluid elements 10A and 10B form, on the water landing plane P, the respective water landing regions inclined at the predetermined angles. In the present embodiment, the first water landing region A1 formed by the fluid element 10A and the second water landing region A2 formed by the fluid element 10B are formed to be lower toward the center side of the shower head main body 20 and to be higher toward both end portions of the shower head main body 20. As a result, as illustrated in FIG. 13, the first water landing region A1 and the second water landing region A2 cross in a V shape at a predetermined height below a substantial center in the left and right direction of the shower head main body 20.

Therefore, as illustrated in FIG. 13, the hot water that has been spouted from the fluid element 10A and has landed on the first water landing region A1 and the hot water that has been spouted from the fluid element 10B and has landed on the second water landing region A2 join with each other at a point where they cross in a V shape. In this way, when the hot water that has hit on the first water landing region A1 joins with the hot water that has hit on the second water landing region A2, the hot water is temporarily blocked, which causes an increase in the time for which the hot water stays on the water landing plane P (the body surface of the user).

This can provide a satisfactory water volume feeling for the user even when the volume of the water spouted from the shower head main body 20 is relatively small. Since the time for which the hot water stays on the body surface of the user is increased, the hot water can provide a large amount of heat for the user, which makes it possible to sufficiently warm the body of the user. Furthermore, since the first water landing region A1 and the second water landing region A2 are inclined to be lower toward the center of the shower head main body 20, the hot water spouted from the fluid elements 10A and 10B is less likely to hit on the face of the user. On the other hand, since at both end portions of the shower head main body 20, the first water landing region A1 and the second water landing region A2 are located at higher positions, the hot water hits on the vicinity of both shoulders of the user, which makes it possible to effectively warm the user.

According to the shower device of the third embodiment of the present invention, the first water landing region A1 and the second water landing region A2 cross. Therefore, in the body surface of the user, the hot water that has landed on the first water landing region A1 and the hot water that has landed on the second water landing region A2 interfere with each other at the crossing of the water landing regions, which makes it easy for the hot water to stay on the body surface of the user. This increases the volume of hot water staying on the body surface of the user taking a shower with respect to the volume of water spouted from the shower head main body 20, which enables a satisfactory water volume feeling to be provided for the user even when the volume of the water spouted from the shower head main body 20 is relatively small. Since the time for which the hot water stays on the body surface of the user is increased, the hot water can provide a large amount of heat for the user, which makes it possible to sufficiently warm the body of the user. As a result, a satisfactory water volume feeling and warmth can be provided for the user while achieving water saving.

According to the shower device of the present embodiment, the first water landing region A1 and the second water landing region A2 cross in a V shape at a predetermined height below a substantial center in the left-and-right direction of the shower head main body 20. This enables the first and second water landing regions to be formed at relatively high positions of the upper body of the user while preventing the shower spouting water from directly landing on the vicinity of the face of the user, which makes it possible to increase the time for which the landed hot water flows downward on the body surface of the user and to sufficiently warm the user.

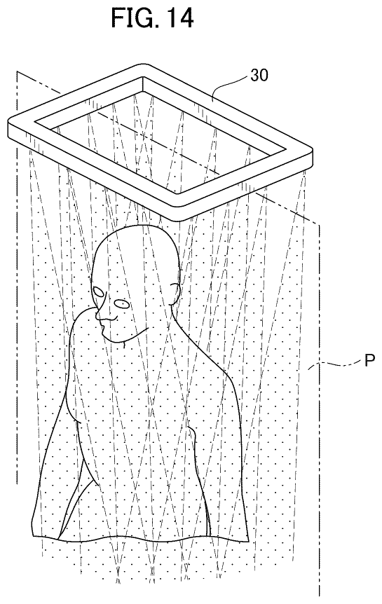

Next, a shower device according to a fourth embodiment of the present invention will be described with reference to FIG. 14.

The shower device of the present embodiment is different from those of the above-described first to third embodiments in a shape of a shower head main body. Accordingly, hereinafter, only features of the fourth embodiment of the present invention which are different from those of the first to third embodiments will be described, and the same configuration, functions, and effects as those in the first to third embodiments are not described. FIG. 14 is a perspective view illustrating a state where the user is taking a shower with shower spouting water from the shower device according to the fourth embodiment of the present invention.

As illustrated in FIG. 14, a shower head main body 30 provided in the shower device according to the fourth embodiment of the present invention is formed into a rectangular ring shape. A plurality of nozzle units are provided along the shower head main body 30 formed into a ring shape, and the shower spouting water is formed to surround the head of the user. The hot water spouted from each nozzle unit is configured to fall while spreading in a flat fan shape. The shower spouting water spreading in a fan shape is oriented parallel to the corresponding side of the shower head main body 30, joins with each other at a position where it falls a predetermined distance from each nozzle unit, and then forms a water film around the body of the user. Furthermore, each nozzle unit is attached to be inclined obliquely downward so that the shower spouting water therefrom is spouted toward the center of the shower head main body 30, and the spouted hot water lands on a virtual water landing plane oriented in the vertical direction below the shower head main body. The shower spouting water spreading in a fan shape is oriented parallel to the corresponding side of the shower head main body 30, whereas water landing regions formed by a first nozzle unit and a second nozzle unit among the plurality of nozzle units at least partially overlap with each other in the vertical direction. Note that examples of the plurality of nozzle units provided in the shower head main body 30 may include a fluid element illustrated in FIG. 3, a nozzle illustrated in FIG. 9, and any configuration.

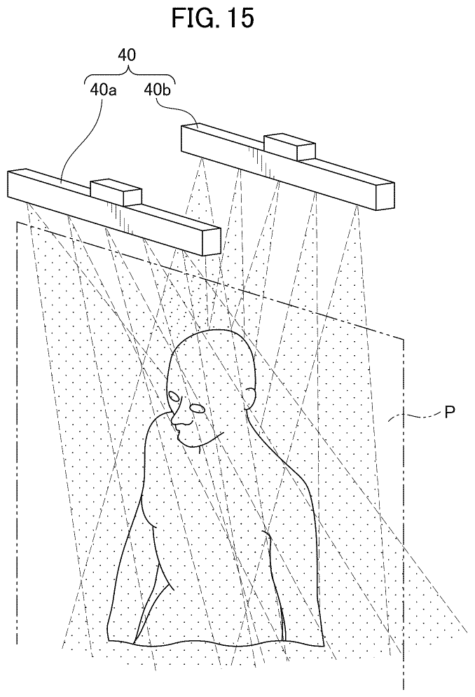

Next, a shower device according to a fifth embodiment of the present invention will be described with reference to FIG. 15.

The shower device of the present embodiment is different from those of the above-described first to fourth embodiments in a shape of a shower head main body. Accordingly, hereinafter, only features of the fifth embodiment of the present invention which are different from those of the first to fourth embodiments will be described, and the same configuration, functions, and effects as those in the first to fourth embodiments are not described. FIG. 15 is a perspective view illustrating a state where the user is taking a shower with shower spouting water from the shower device according to the fifth embodiment of the present invention.

As illustrated in FIG. 15, a shower head main body 40 provided in the shower device according to the fifth embodiment of the present invention includes two linear shower head main bodies 40a and 40b. A plurality of nozzle units are provided along the linear shower head main bodies 40a and 40b, and the shower spouting water is formed to surround the head of the user. Here, the hot water spouted from each nozzle unit is configured to fall while spreading in a flat fan shape. Furthermore, the nozzle units provided at a center portion of each shower head main body 40a, 40b spout the fan-shaped shower spouting water parallel to a direction in which each shower head main body 40a, 40b extends. In contrast, the nozzle units provided in the vicinity of end portions of each shower head main body 40a, 40b spout the fan-shaped shower spouting water oriented approximately perpendicular to the direction in which each shower head main body 40a, 40b extends.

Furthermore, the nozzle units provided in each shower head main body 40a, 40b are oriented obliquely downward in a direction in which the spouted shower spouting water mutually approaches, and the spouted hot water lands on a virtual water landing plane oriented in the vertical direction below the shower head main body. Therefore, a water spouting space surrounded by the spouted hot water is formed to narrow downward. The shower spouting water spouted from the center portion of each shower head main body 40a, 40b spreads in a fan shape parallel to the corresponding shower head main body 40a, 40b, and water landing regions formed by a first nozzle unit and a second nozzle unit among the plurality of nozzle units at least partially overlap with each other in the vertical direction. That is, the shower spouting water spouted from nozzle units provided in the vicinity of the end portions of the shower head main bodies 40a and 40b joins with each other at a position where it falls a predetermined distance. Therefore, the head of the user standing between the two shower head main bodies 40a and 40b is surrounded by the shower spouting water spouted from the two shower head main bodies 40a and 40b formed linearly. Note that examples of the plurality of nozzle units provided in the shower head main body 40 may include a fluid element illustrated in FIG. 3, a nozzle illustrated in FIG. 9, and any configuration.

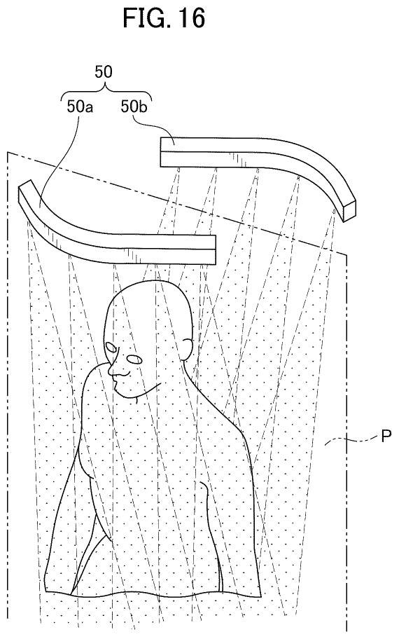

Next, a shower device according to a sixth embodiment of the present invention will be described with reference to FIG. 16.

The shower device of the present embodiment is different from that of the above-described fifth embodiment in a shape of a shower head main body. Accordingly, hereinafter, only features of the sixth embodiment of the present invention which are different from those of the fifth embodiment will be described, and the same configuration, functions, and effects as those in the fifth embodiment are not described. FIG. 16 is a perspective view illustrating a state where the user is taking a shower with shower spouting water from the shower device according to the sixth embodiment of the present invention.

As illustrated in FIG. 16, a shower head main body 50 provided in the shower device according to the sixth embodiment of the present invention includes two shower head main bodies 50a and 50b extending in a curved manner. Each shower head main body 50a, 50b extends in a curved manner so that both end portions thereof mutually approach, and a plurality of nozzle units are provided along each shower head main body 50a, 50b. In this way, the shower spouting water is formed to surround the head of the user. Here, the hot water spouted from each nozzle unit is configured to fall while spreading in a flat fan shape. Furthermore, the nozzle units provided at a center portion of each shower head main body 50a, 50b spout the fan-shaped shower spouting water spreading generally tangentially to a direction in which each shower head main body 50a, 50b extends. In contrast, the nozzle units provided in the vicinity of end portions of each shower head main body 50a, 50b spout the fan-shaped shower spouting water at an angle close to a right angle with respect to the direction in which each shower head main body 50a, 50b extends.

Furthermore, the nozzle units provided in each shower head main body 50a, 50b spout hot water obliquely downward in a direction in which the spouted shower spouting water mutually approaches, and the spouted hot water lands on a virtual water landing plane oriented in the vertical direction below the shower head main body. Therefore, a water spouting space surrounded by the spouted hot water is formed to narrow downward. The shower spouting water spouted from nozzle units provided in the vicinity of the end portions of the shower head main bodies 50a and 50b joins with each other at a position where it falls a predetermined distance. Therefore, the head of the user standing between the two shower head main bodies 50a and 50b is surrounded by the shower spouting water spouted from the two shower head main bodies 50a and 50b formed in a curved manner. Furthermore, the shower spouting water spouted from the center portion of each shower head main body 50a, 50b spreads in a fan shape at a predetermined angle, and water landing regions formed by a first nozzle unit and a second nozzle unit among the plurality of nozzle units cross in a V shape at a predetermined height below a substantial center in the left-and-right direction of the shower head main body. Note that examples of the plurality of nozzle units provided in the shower head main body 50 may include a fluid element illustrated in FIG. 3, a nozzle illustrated in FIG. 9, and any configuration.

Next, a shower device according to a seventh embodiment of the present invention will be described with reference to FIGS. 17 to 22.

The shower device of the present embodiment is different from that of the above-described first embodiment in a structure in which hot water is supplied to each nozzle unit of a shower head main body. Accordingly, hereinafter, only features of the seventh embodiment of the present invention which are different from those of the first embodiment will be described, and the same configuration, functions, and effects as those in the first embodiment are not described.

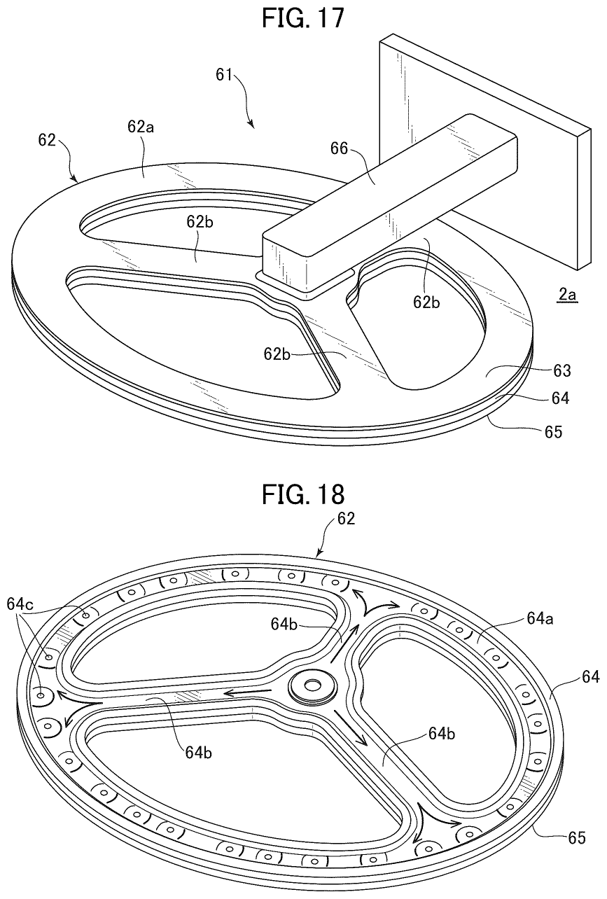

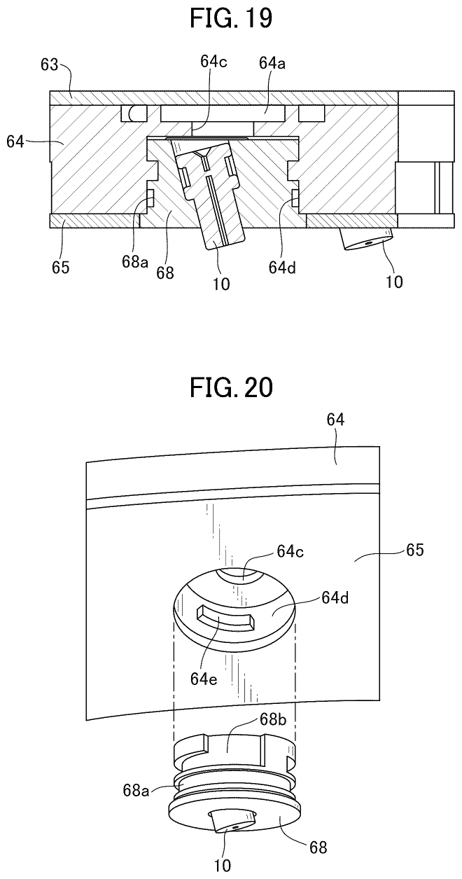

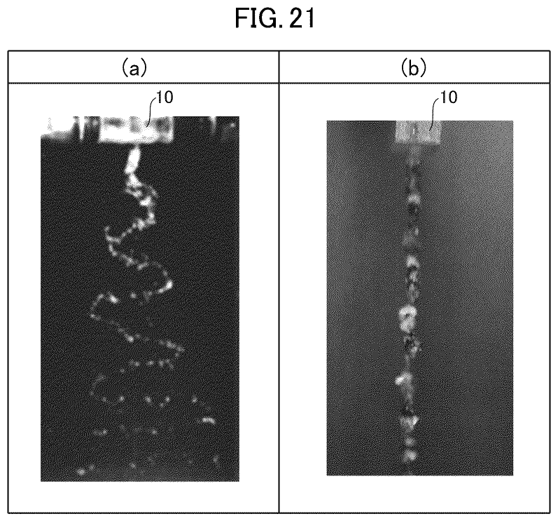

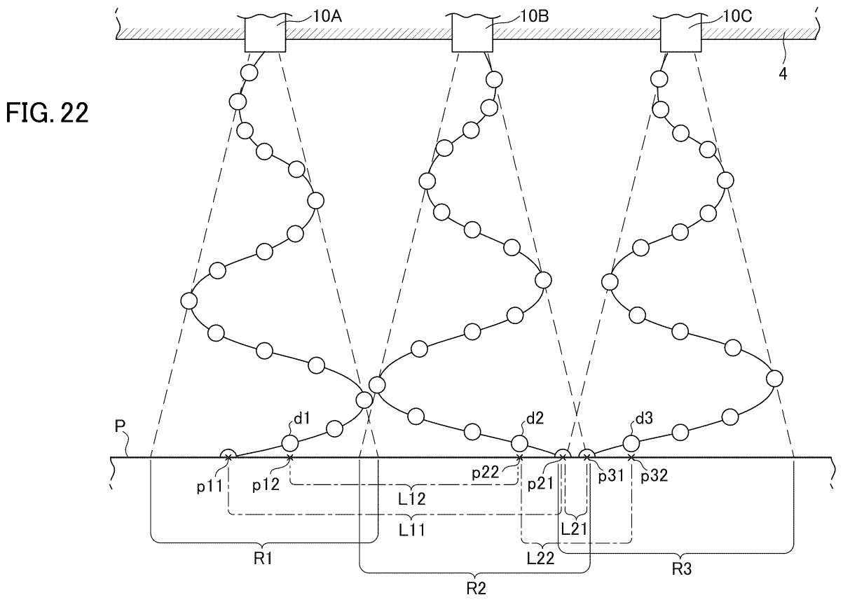

FIG. 17 is a perspective view illustrating the shower device according to the seventh embodiment of the present invention. FIG. 18 is a perspective view illustrating a state where an upper cover of the shower head main body provided in the shower device according to the seventh embodiment of the present invention is detached. FIG. 19 is a cross-sectional view illustrating the shower head main body provided in the shower device according to the seventh embodiment of the present invention. FIG. 20 is an exploded perspective view illustrating an attachment structure of a nozzle unit in the shower device according to the seventh embodiment of the present invention. FIG. 21 is a diagram illustrating an example of hot water spouted from a fluid element in the shower device according to the seventh embodiment of the present invention. FIG. 22 is a diagram schematically illustrating hot water spouted from first to third fluid elements provided in the shower head main body of the shower device according to the seventh embodiment of the present invention.

As illustrated in FIG. 17, a shower device 61 of the present embodiment is fixed to a side wall surface 2a of a shower room. The shower device 61 includes a shower head main body 62, and a support member 66 for attaching the shower head main body 62 to the side wall surface 2a.

The shower head main body 62 is an elliptical ring-shaped member as a whole, and is provided with a plurality of nozzle units arranged at intervals along the elliptical ring. The shower head main body 62 includes an elliptical ring-shaped annular portion 62a, and three water supply portions 62b extending radially from a center of the annular portion 62a.

The annular portion 62a is an elliptical ring-shaped portion, and a plurality of nozzle units are provided at intervals on a lower surface of the annular portion 62a. As described later, a water supply passage for supplying hot water to each nozzle unit is provided inside the annular portion 62a. On the other hand, the water supply portions 62b extend radially from the center of the annular portion 62a, and the water supply portions 62b have respective distal ends connected to the annular portion 62a. Specifically, one water supply portion 62b extends toward the side wall surface 2a from the center of the annular portion 62a, the two remaining water supply portions 62b extend in a direction opposite to the side wall surface 2a, and the water supply portions 62b have the respective distal ends connected to the annular portion 62a. The lengths between three points where the distal ends of the water supply portions 62b are connected to the annular portion 62a are configured to be equal to each other.

Next, the support member 66 is a member attached to extend in a generally horizontal direction from an upper portion of the side wall surface 2a, and is configured to support the shower head main body 62 at a predetermined height. Furthermore, the support member 66 is connected to an upper surface of the shower head main body 62, and a distal end of the support member 66 is coupled to a joining portion of the three water supply portions 62b at the center of the shower head main body 62. A water supply passage (not illustrated) is provided inside the support member 66, and hot water supplied through the water supply passage flows into each water supply portion 62b of the shower head main body 62, and is spouted from each nozzle unit provided in the lower surface of the annular portion 62a.

Note that, in the present embodiment, the shower head main body 62 is rigidly joined to a distal end portion of the support member 66, but as a modified example, a ball joint (not illustrated) is provided between the support member 66 and the shower head main body 62 so that the shower head main body 62 can be angle-adjustably fixed to the support member 66. In this case, the ball joint (not illustrated) is provided between the distal end of the support member 66 and the joining portion of the three water supply portions 62b, so that the ball joint is located in the vicinity of the center of gravity of the shower head main body 62. Therefore, the moment of the force acting on a center of rotation of the ball joint based on the center of gravity acting on the shower head main body 62 is relatively small, and using the ball joint, the shower head main body 62 can be easily fixed at any angular position.

Furthermore, the shower head main body 62 includes an upper cover 63, a flow channel forming member 64, and a lower cover 65, and the upper cover 63 and the flow channel forming member 64 are coupled to thereby form a water supply passage for supplying hot water to each nozzle unit of the shower head main body 62.

As illustrated in FIG. 18, the flow channel forming member 64 includes a ring-shaped portion and three linear portions extending radially from the center of the ring-shaped portion. The ring-shaped portion forms a part of the annular portion 62a of the shower head main body 62, and each linear portion forms a part of the water supply portion 62b. Furthermore, an annular passage 64a extending in a ring shape is formed in the ring-shaped portion to encircle the interior of the annular portion 62a, and a distribution passage 64b is formed in each linear portion. That is, the three distribution passages 64b extend radially from the center of the shower head main body 62, and the distal ends thereof communicate with the annular passage 64a. In this way, the hot water flows into the annular passage 64a from a plurality of portions via each distribution passage 64b.

On the other hand, a plurality of communication holes 64c are provided along the annular passage 64a, and these communication holes 64c each communicate to a corresponding nozzle unit attaching concave portion 64d (FIG. 19) provided on a lower surface side of the flow channel forming member 64. Each nozzle unit attaching concave portion 64d communicates with the annular passage 64a formed in the annular portion 62a of the shower head main body 62, and hot water is supplied to a fluid element 10 (FIG. 19) attached in each nozzle unit attaching concave portion 64d.

Next, as illustrated in FIGS. 19 and 20, the plurality of nozzle unit attaching concave portions 64d are provided along the annular passage 64a on the lower surface side of the flow channel forming member 64. As in the above-described first embodiment, each nozzle unit attaching concave portion 64d is formed into a substantially cylindrical shape, and a nozzle unit holding member 68 holding the fluid element 10, which is a nozzle unit, is detachably fitted into the nozzle unit attaching concave portion 64d. The structure of the fluid element 10 is similar to that in the above-described first embodiment, and therefore is not described here.

The nozzle unit holding member 68 is a substantially columnar member as a whole, and is configured to hold the fluid element 10, which is the nozzle unit. The nozzle unit holding member 68 holds the fluid element 10 so that the fluid element 10 is inclined at a predetermined angle with respect to a central axis. In this way, the hot water is spouted obliquely downward from the shower head main body 62. A groove 68a is provided on an outer periphery of the nozzle unit holding member 68, and an O-ring (not illustrated) is disposed in the groove 68a, thereby ensuring the water-tightness between the nozzle unit holding member 68 and the nozzle unit attaching concave portion 64d.

Furthermore, as illustrated in FIG. 20, mounting grooves 68b (only one is illustrated in FIG. 20) are provided at two portions on an outer peripheral surface of the nozzle unit holding member 68. Each mounting groove 68b is formed into a hook shape, and includes an axial portion extending in an axial direction from an upper end of the nozzle unit holding member 68, and a circumferential portion extending in a circumferential direction of the nozzle unit holding member 68 from a lower end of the axial portion. On the other hand, in the inner wall surface of the nozzle unit attaching concave portion 64d, two engaging projections 64e (only one is illustrated in FIG. 20) each are provided at a position corresponding to the axial portion of each mounting groove 68b.

When the nozzle unit holding member 68 is mounted, first, the nozzle unit holding member 68 is fitted into the nozzle unit attaching concave portion 64d so that each engaging projection 64e is received into the axial portion of each mounting groove 68b. Next, each engaging projection 64e is received in the circumferential portion of each mounting groove 68b by turning the nozzle unit holding member 68, whereby the nozzle unit holding member 68 can be fixed to the flow channel forming member 64. Note that in the present embodiment, the fluid element 10 held in the nozzle unit holding member 68 is configured to be oriented in a proper direction by turning the nozzle unit holding member 68 until each engaging projection 64e contacts an end of the circumferential portion of each mounting groove 68b.

Note that, as in the above-described first embodiment, each fluid element 10 provided in the shower head main body 62 is attached so that the vibration plane (a plane parallel to drawing sheet of FIG. 4) of hot water to be jetted is oriented in a tangential direction of the elliptical annular portion 62a. The intervals between the fluid elements 10 are not constant, and the intervals are adjusted so that the user can be comfortably enveloped by the hot water to be jetted from the fluid elements 10. In the present embodiment, the interval between the fluid elements 10 adjacent to each other is set to about 43 mm to about 167 mm. The interval between the fluid elements 10 is preferably set to about 30 mm to about 200 mm. In contrast, in the conventional typical disk-shaped overhead shower, nozzle holes are uniformly provided to the entire shower head at the interval of about 10 mm to about 30 mm.

Next, an operation of the shower device 61 according to the seventh embodiment of the present invention will be described.

First, when the user performs an operation of starting water spouting from the shower device 61, the supply of hot water to the shower device 61 is started. The supplied hot water flows into the shower head main body 62 through a water supply passage (not illustrated) formed inside the support member 66. The hot water that has flowed into the shower head main body 62 branches into three at the joining portion of the three water supply portions 62b. That is, the hot water supplied to the shower head main body 62 is distributed to the three distribution passages 64b in the water supply portions 62b as indicated by arrows in FIG. 18, and flows into the annular passage 64a from the distal ends of the respective distribution passages 64b.

The hot water that has entered the annular passage 64a from the distal ends of the respective distribution passages 64b branches into two and flows into the annular passage 64a in both directions as indicated by arrows in FIG. 18, and spreads over the entire annular passage 64a. This causes the hot water to flow into each nozzle unit attaching concave portion 64d through each communication hole 64c provided along the annular passage 64a. The hot water that has flowed into the nozzle unit attaching concave portion 64d flows into the fluid element 10 held by the nozzle unit holding member 68 fitted into the nozzle unit attaching concave portion 64d. The hot water supplied to each fluid element 10 is spouted while vibrating reciprocatingly.

Here, in the present embodiment, the hot water supplied to the shower head main body 62 flows into the annular passage 64a after being distributed into the three distribution passages 64b. Therefore, the distance of the water supply passage passing from the water supply source to each fluid element is uniform, and the hot water is supplied to each fluid element 10 at a relatively uniform water supply pressure. As a result, the flow rate of the hot water to be spouted from each fluid element 10 is more uniform, and a showering feeling felt by the user is more uniform.

For example, when the pressure of the hot water supplied to some fluid elements 10 among the plurality of fluid elements 10 is low, the hot water to be jetted does not vibrate reciprocatingly at an amplitude as designed, and may not overlap sufficiently with the spouting water from the adjacent fluid element 10. When the pressure of the hot water supplied to the fluid elements 10 is low, the force of hot water to be spouted is weak, and therefore the hot water may not land on the user at an angle as designed. According to the shower device 61 of the present embodiment, the hot water is distributed by the distribution passages 64b, whereby the hot water can be supplied to each fluid element 10 at a relatively uniform water supply pressure, and even when the water supply pressure is low, the shower spouting water can be performed substantially as designed.

Next, FIG. 21 is a diagram illustrating an example of hot water spouted from a fluid element 10. Column (a) in FIG. 21 shows a photograph, which is taken from a direction perpendicular to the vibration plane, of the hot water spouted from the fluid element 10, and Column (b) shows a photograph, which is taken from a direction parallel to the vibration plane. As shown in Column (a) of FIG. 21, the hot water spouted from the fluid element 10 vibrates in a sine wave pattern by swinging the spouting angle in the vibration plane, and falls while spreading in the direction parallel to the vibration plane. On the other hand, as shown in Column (b) of FIG. 21, the hot water spouted from the fluid element 10 falls while maintaining the spout width, with almost no spread in the direction perpendicular to the vibration plane. As a result, the hot water spouted from the fluid element 10 lands on an almost linear region.

FIG. 22 is a diagram schematically illustrating hot water spouted from a first fluid element 10A, a second fluid element 10B, and a third fluid element 10C, which are arranged, among the plurality of fluid elements 10 provided in the shower head main body 62. As illustrated in FIG. 22 in the shower device 61 of the present embodiment, the angle of the hot water spouted from each fluid element is swung at generally the same period and the same amplitude.

In the shower device 61 of the present embodiment, since the lengths of the flow channels from the joining point of the water supply portions 62b to each fluid element 10 are different, the timings when the oscillation is started in each fluid element 10 are different, and the phases of the angle changes of the hot water spouted from the fluid elements arranged adjacent to each other are differently configured.

As illustrated in FIG. 22, the hot water spouted from the first fluid element 10A lands on a virtual water landing plane P oriented in the horizontal direction, the water landing plane P being set at a predetermined height below the shower head main body 62. Then, the hot water spouted from the first fluid element 10A lands on a water landing region R1 extending linearly on the water landing plane P. That is, a water landing point of the hot water spouted from the first fluid element 10A moves reciprocatingly on the water landing region R1. Similarly, the hot water spouted from the second fluid element 10B lands on a water landing region R2 on the water landing plane P, and the water landing point moves reciprocatingly on the water landing region R2. Furthermore, the hot water spouted from the third fluid element 100 lands on a water landing region R3 on the water landing plane P, and the water landing point moves reciprocatingly on the water landing region R3.

At a moment illustrated in FIG. 22, the hot water spouted from the first fluid element 10A lands on a point p11, the hot water spouted from the second fluid element 10B lands on a point p21, and the hot water spouted from the third fluid element 10C lands on a point p31. At a moment shortly after the moment illustrated in FIG. 22, the hot water that has been spouted from the first fluid element 10A and located at a point d1 lands on the vicinity of a point p12, the hot water that has been spouted from the second fluid element 10B and located at a point d2 lands on the vicinity of a point p22, and the hot water that has been spouted from the third fluid element 10C and located at a point d3 lands on the vicinity of a point p32.

Incidentally, with attention to each water landing point on the water landing plane P, after the hot water lands on the point p11 at the moment illustrated in FIG. 22, the hot water lands on this point after a predetermined time period has elapsed since the moment, and therefore, the hot water does not land on the point during the predetermined time period. In other words, regarding each point on the water landing region R1, the hot water actually lands only on one or two water landing points during one reciprocative movement in the water landing region R1, and the hot water does not land on the other time points. In this way, in the shower device 61 of the present embodiment, since the water landing points are “thinned out” temporally, the total volume of hot water to be spouted can be reduced.

In contrast, in the conventional shower device, since the water lands continuously on the entire water landing region, the total volume of hot water to be spouted is extremely large. Alternatively, when the intervals between nozzle holes (not illustrated) are increased to reduce the total volume of hot water in the conventional shower device, the user feels that the spouting water is “sparsely” provided, which causes uncomfortable showering. When the intervals between nozzle holes (not illustrated) are reduced and the flow rate of the hot water spouted from the nozzle holes is reduced to reduce the total volume of hot water, the user feels that the force of water to be spouted is weak, which causes uncomfortable showering.

On the other hand, in the shower device 61 of the present embodiment, the water landing points are “thinned out” temporally, but the flow rate of water landing on each water landing point is relatively large, which provides appropriate skin irritation for the user and leads to comfortable showering.

The water landing points of the hot water spouted from each fluid element move reciprocatingly in the water landing region, but the phases when the angle of the hot water spouted from each fluid element is swung are shifted from each other, and therefore, the distance between the water landing points always changes. That is, at a moment illustrated in FIG. 22, the hot water spouted from the first fluid element 10A lands on the point p11, and the hot water spouted from the second fluid element 10B lands on the point p21. Then, at a next moment of FIG. 22, the water landing points of the hot water spouted from the first and second fluid elements move to the point p12 and the point p22, respectively. In this way, a distance between the water landing points of the hot water spouted from the first and second fluid elements arranged adjacent to each other is a distance L11 between the point p11 and the point p21 at the moment illustrated in FIG. 22, and changes to a distance L12 between the point p12 and the point p22 at the next moment.

In other words, in the shower device 61 of the present embodiment, the hot water spouted from the first fluid element 10A and the second fluid element 10B arranged adjacent to each other lands on the virtual water landing plane P arranged in the horizontal direction below the shower head main body 62. Then, the first water landing point p11, p12, . . . of the hot water spouted from the first fluid element 10A and the second water landing point p21, p22, . . . of the hot water spouted from the second fluid element 10B move on the virtual water landing plane P. Further, the distance L11, L12 . . . between the first water landing point p11, p12, . . . and the second water landing point p21, p22, . . . always changes.

Similarly, a distance between the water landing points of the hot water spouted from the second fluid element 10B and the third fluid element 10C arranged adjacent to each other is a distance L21 between the point p21 and the point p31 at the moment illustrated in FIG. 22, and changes to a distance L22 between the point p22 and the point p32 at the next moment. Accordingly, in the example illustrated in FIG. 22, the distance L21, L22, . . . between the second water landing point of the hot water spouted from the second fluid element 10B and the third water landing point of the hot water spouted from the third fluid element 10C also always changes.

In the shower device 61 of the present embodiment, since the spouting water from each fluid element 10 is swung (reciprocative vibration), even when the intervals between the fluid elements 10 are set to 30 mm or more, the user can obtain comfortable showering, and therefore, the comfortable showering can be provided while satisfying water saving request by allowing space between the fluid elements 10. In addition, in the shower device 61 of the present embodiment, since the phases when the angle of the hot water spouted from the first and second fluid elements arranged adjacent to each other is swung are differently configured, the distance between the water landing points always changes. This makes it difficult for the user to predict the movement of each water landing point, and the user can feel that the hot water always hits on the wider area. Here, the phases when the angle of the hot water spouted from each fluid element 10 is swung can be set according to the supply state of the hot water to each fluid element from the water supply source.

In the shower device 61 of the present embodiment, since the lengths of the flow channels from the joining point of the water supply portions 62b to each fluid element 10 are different, the timings when the oscillation is started in each fluid element 10 are different, and the hot water is swung at a different phase. Note that, also in the shower device 61 of the present embodiment, as for certain two fluid elements 10 adjacent to each other, the lengths of the flow channels to the fluid elements 10 are equal to each other, and the hot water from the two fluid elements 10 is swung at the same phase. However, since as for other two fluid elements 10 adjacent to each other, the hot water spouted therefrom is swung at a different phase, the user cannot predict the movement of the water landing points, and the user can feel that the hot water always hits on the wider area.

Note that in the shower head main body 62 of the present embodiment, each fluid element can be oriented so that the water landing region is formed in a similar manner to in the above-described first to third embodiments (FIGS. 6, 10, and 13). In FIGS. 14 to 16 illustrating the above-described fourth to sixth embodiments of the present invention, a supply path in which the supplied hot water flows into the shower head main body is not illustrated, but as in the above-described seventh embodiment, the distribution passage can be used to supply the hot water to the shower head main body.

For example, in the fourth embodiment illustrated in FIG. 14, a cross distribution passage (not illustrated) can be provided in which the middle points of the long sides of the shower head main body 30 are connected to each other, and the middle points of the short sides thereof are connected to each other. In this case, the present invention may be configured so that the hot water supplied from the support member flows in from the cross intersection, and the hot water flows in from four portions of the rectangular ring shaped shower head main body 30 through the distribution passage. Therefore, the distance of the water supply passage passing from the water supply source to each fluid element is uniform, and the hot water can be supplied to each nozzle unit provided in the shower head main body 30 at a relatively uniform water supply pressure.

In the fifth and sixth embodiments illustrated in FIGS. 15 and 16, a distribution passage (not illustrated) extending in a front and rear direction can be provided in which the middle points of two shower head main bodies separated in the front-and-rear direction are connected to each other. In this case, the present invention may be configured so that the hot water supplied from the support member flows in from the middle point of the distribution passage, and the hot water flows in from the center of each shower head main body through the distribution passage. Therefore, the distance of the water supply passage passing from the water supply source to each fluid element is uniform, and the hot water can be supplied to each nozzle unit provided in the shower head main body at a relatively uniform water supply pressure.

The preferred embodiments of the present invention have been described above, but various changes may be added to the above-described embodiments.

### REFERENCE SIGNS LIST

1 shower device
2 shower room
2a side wall surface
4 shower head main body
4a water supply passage
4b nozzle unit attaching concave portion
6 support member
8 nozzle unit holding member
10 fluid element (nozzle unit)
10A fluid element (first nozzle unit)
10B fluid element (second nozzle unit)
10C fluid element (third nozzle unit)
10a water spouting port
10b flange portion
10c groove
10d water inlet
12a water supply passage
12b vortex street passage
12c rectifying passage
14 step portion
16 hot water collision part
18 nozzle
18a passage
18b inner wall surface
17c groove
19 shower head main body
20 shower head main body
30 shower head main body
40 shower head main body
40a, 40b shower head main body
50 shower head main body
50A, 50b shower head main body
61 shower device
62 shower head main body
62a annular portion
62b water supply portion
68 upper cover
64 flow channel forming member
64a annular passage
64b distribution passage
64c communication hole
64d nozzle unit attaching concave portion
64e engaging projection
65 lower cover
66 support member
68 nozzle unit holding member
68a groove
68b mounting groove

What is claimed is:

1. A shower device fixed to enable a user to be showered from above with shower spouting water, the shower device comprising:
a shower head main body; and
a plurality of nozzle units provided in the shower head main body at intervals so as to form the shower spouting water surrounding a head of the user standing below the shower head main body, wherein
each of the nozzle units is configured so that the spouted water falls while spreading downward.

2. The shower device according to claim 1, wherein
each of the nozzle units is configured so that the spouted water joins with each other at a position falling a predetermined distance from each of the nozzle units, and a water film is formed around a body of the user.

3. The shower device according to claim 1, wherein
each of the nozzle units is oriented so that a space surrounded by the spouted water is formed to narrow downward.

4. The shower device according to claim 1, wherein
the shower head main body is formed into a ring shape.

5. The shower device according to claim 1, wherein
each of the nozzle units is configured so that the spouted water vibrates reciprocatingly in a sine wave pattern, whereby the spouted water falls while spreading downward.

6. The shower device according to claim 1, wherein
among the plurality of nozzle units, a first nozzle unit and a second nozzle unit are configured to spout water forming respective linearly-extending water landing regions with respect to a same side of a virtual water landing plane oriented in a vertical direction below the shower head main body, and
the first nozzle unit and the second nozzle unit are configured so that a first water landing region formed by the first nozzle unit and a second water landing region formed by the second nozzle unit at least partially overlap with each other in the vertical direction on the same side of the virtual water landing plane.

7. The shower device according to claim 6, wherein
the first water landing region is formed above the second water landing region, the second nozzle unit is configured so that the spouted water falls while spreading in a horizontal direction, and the water that hits on the first water landing region and falls joins with the water that has landed on the second water landing region to spread in the horizontal direction.

8. The shower device according to claim 1, wherein
among the plurality of nozzle units, a first nozzle unit and a second nozzle unit are configured to spout water forming respective linearly-extending water landing regions with respect to a same side of a virtual water landing plane oriented in a vertical direction below the shower head main body, and
the first nozzle unit and the second nozzle unit are configured so that a first water landing region formed by the first nozzle unit crosses a second water landing region formed by the second nozzle unit on the same side of the virtual water landing plane.

9. The shower device according to claim 8, wherein
the first water landing region and the second water landing region cross in a V shape at a predetermined height below a substantial center in a left-and-right direction of the shower head main body on the virtual water landing plane.

10. The shower device according to claim 6, wherein
the shower head main body is formed in a ring shape, and includes an annular portion provided with an annular passage in the annular portion, and a water supply portion that is coupled to the annular portion and provided with a plurality of distribution passages in the water supply portion, wherein the water flows into the annular passage from a plurality of portions via each of the distribution passages.
